(19) United States
(12) Patent Application Publication
(10) Pub. No.: US 2010/0208316 A1
(43) Pub. Date: Aug. 19, 2010

(54) Holographic exposure apparatuses

(75) Inventors: Oui Serg Kim, Seoul (KR); Sung Hwi Cho, Seongnam-si (KR); Kyen Hee Lee, Seongnam-si (KR); Sang Joon Hong, Suwon-si (KR); Sang Wook Park, Suwon-si (KR); In Bae Jang, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/656,293

(22) Filed: Jan. 25, 2010

(30) Foreign Application Priority Data
Feb. 17, 2009 (KR) 10-2009-0012711

(51) Int. Cl. G03H 1/20; G03B 27/58

(52) U.S. Cl. 359/12; 355/72

(57) ABSTRACT

A holographic exposure apparatus may include a main body, a mask stage supported by the body, a holographic mask supported by the mask stage, and a driving unit disposed between the body and mask stage. A holographic exposure apparatus may include an object supported by a substrate stage, a holographic mask spaced apart from the object and supported by a mask stage, a main body supported by the mask stage, and a driving unit disposed between the mask stage and body to control a gap between the mask stage and body. A holographic exposure apparatus may include a main body, a mask stage supported by the body, a holographic mask supported by the mask stage, and a piezoelectric element disposed between the body and mask stage. The body may include a support arm that supports the element. The mask stage may include a seat arm that supports the element.

### CROSS-REFERENCE TO RELATED APPLICATION(S)

This application claims priority from Korean Patent Application No. 2009-0012711, filed on Feb. 17, 2009, in the Korean Intellectual Property Office (KIPO), the entire contents of which are incorporated herein by reference.

### BACKGROUND

1. Field

Example embodiments relate to holographic exposure apparatuses that may adjust a gap between an object to be exposed and a holographic mask.

2. Description of the Related Art

Total Internal Reflection (TIR) holographic exposure technology may be applied to patterning processes of a semiconductor Integrated Circuit (IC) or Liquid Crystal Display (LCD) pattern. This exposure technology may include recording a desired pattern onto a holographic mask and/or exposing a photoresist by irradiating a reconstructing beam onto the holographic mask.

In the recording, a recording laser beam may be irradiated onto a mask pattern (former reticle) corresponding to a pattern of an exposure apparatus so as to produce a diffracted beam to be radiated onto a recording surface of a holographic mask. Meanwhile, a reference beam may be irradiated onto the recording surface of the holographic mask from the back side of the holographic mask at an angle (that may or may not be predetermined) so as to interfere with the diffracted beam emitted from the mask pattern. In this way, an interference pattern may be produced and/or recorded on the recording surface of the holographic mask.

In the exposing, an exposing beam, which is a reconstructing beam, may be irradiated from the opposite direction to that in the recording onto an object placed at the same position as in the case of the mask pattern so as to expose a photoresist, together with a diffracted beam, to reconstruct the pattern on the photoresist.

In particular, in the exposing, in order to accurately transfer the interference pattern recorded on the holographic mask onto the object to be exposed, a gap between the object and the holographic mask may be appropriately adjusted. Examples of a method of adjusting this gap to be within a depth of focus may include methods of moving an object and/or methods of simultaneously moving a prism and a holographic mask.

### SUMMARY

Example embodiments may provide holographic exposure apparatuses with improved structure in which a mask stage to support a holographic mask may be provided such that a gap between an object and the holographic mask may be adjusted with high accuracy.

Additional aspects of example embodiments will be set forth in part in the description which follows and, in part, will be obvious from the description and/or may be learned by practice of the invention.

According to example embodiments, a holographic exposure apparatus may include a main body, a mask stage supported by the main body, a holographic mask supported by the mask stage, and/or a driving unit disposed between the main body and the mask stage so as to move the mask stage relative to the main body.

The driving unit may include a piezoelectric element and/or a power supply source to supply power to the piezoelectric element.

The piezoelectric element may be disposed so as to receive a compressive force by the load of the mask stage.

The mask stage may include a seat arm located on an upper side of the driving unit, and/or the main body may include a support arm located on a lower side of the driving unit.

The seat arm may be located on an upper side of the mask stage.

The piezoelectric element disposed between the seat arm and the support arm may be located adjacent to the holographic mask.

The seat arm may be located on a lower side of the mask stage.

The holographic exposure apparatus may further include a distance measurement optical system to measure a distance between the holographic mask and an object, and/or an information processing device to control the driving unit based on information transmitted from the distance measurement optical system.

According to example embodiments, a holographic exposure apparatus may include an object supported by a substrate stage, a holographic mask spaced apart from the object and supported by a mask stage, a main body supported by the mask stage, and/or a driving unit disposed between the mask stage and the main body so as to control a gap between the mask stage and the main body.

The driving unit may include a piezoelectric element and/or a power supply to supply power to the piezoelectric element.

The piezoelectric element may be disposed so as to receive a compressive force by the load of the mask stage.

The mask stage may include a seat arm located on an upper side of the driving unit, and/or the main body may include a support arm located on a lower side of the driving unit.

According to example embodiments, a holographic exposure apparatus may include a main body, a mask stage supported by the main body, a holographic mask supported by the mask stage, and/or a piezoelectric element disposed between the main body and the mask stage. The main body may include a support arm to support the piezoelectric element at a lower side thereof, and/or the mask stage may include a seat arm to support the piezoelectric element at an upper side thereof.

According to example embodiments, since the mask stage may be driven with high accuracy, the gap between the holographic mask and the object may be controlled with high accuracy.

In addition, since the piezoelectric element may be disposed so as to receive the compressive force, the load of the mask stage may be easily supported. That is, the limit of the load of the mask stage may be reduced and/or the range of choice for the mask stage may be broadened.

According to example embodiments, a holographic exposure apparatus may include a main body, a mask stage supported by the main body, a holographic mask supported by the mask stage, and/or a driving unit disposed between the main body and the mask stage in order to move the mask stage relative to the main body.

According to example embodiments, a holographic exposure apparatus may include an object supported by a substrate stage, a holographic mask spaced apart from the object and supported by a mask stage, a main body supported by the mask stage, and/or a driving unit disposed between the mask stage and the main body in order to control a gap between the mask stage and the main body.

According to example embodiments, a holographic exposure apparatus may include a main body, a mask stage supported by the main body, a holographic mask supported by the mask stage; and/or a piezoelectric element disposed between the main body and the mask stage. The main body may include a support arm that supports the piezoelectric element at a first side of the piezoelectric element. The mask stage may include a seat arm that supports the piezoelectric element at a second side of the piezoelectric element.

### BRIEF DESCRIPTION OF THE DRAWINGS

These and/or other aspects and advantages will become more apparent and more readily appreciated from the following detailed description of example embodiments, taken in conjunction with the accompanying drawings, in which:

FIG. 1 is a view showing the main configuration of a holographic exposure apparatus according to example embodiments;

FIG. 2 is a view showing a state of coupling a mask stage and a main body according to example embodiments;

FIG. 3 is a view showing a state of coupling a mask stage and a main body according to example embodiments;

FIG. 4 is a view showing a state in which a gap between a holographic mask and a substrate is out of a depth of focus; and

FIG. 5 is a view showing a state in which the gap between the holographic mask and the substrate is within the depth of focus.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

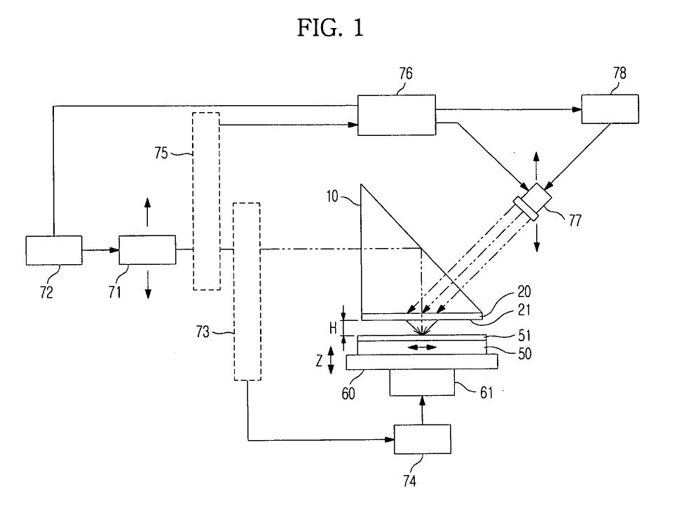

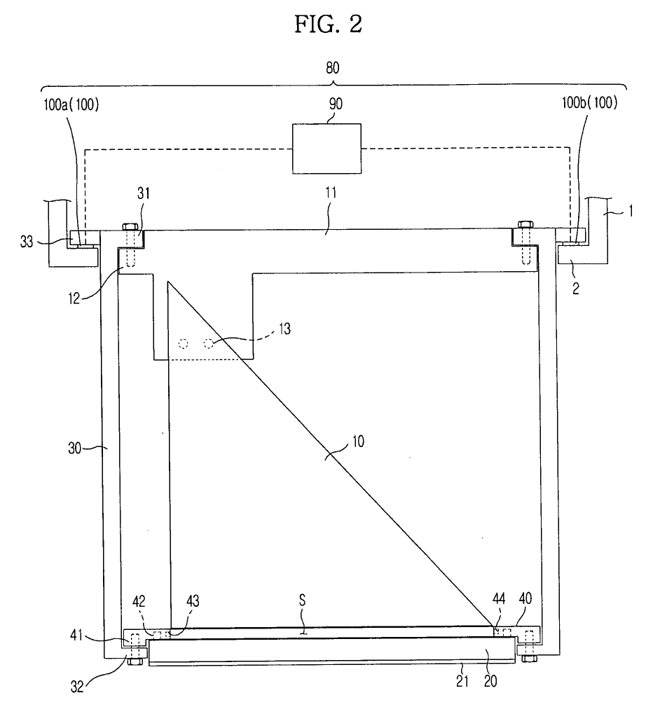

FIG. 1 is a view showing the main configuration of a holographic exposure apparatus according to example embodiments, and FIG. 2 is a view showing a state of coupling a mask stage and a main body according to example embodiments.

As shown in FIG. 1, the exposure apparatus according to example embodiments may include a mask stage 30 to support a prism 10 and/or a holographic mask 20, a substrate stage 60 to support a substrate 50, a detection light source 71, a detection light source driving device 72, a distance measurement optical system 73, a first information processing device 74, a thickness measurement optical system 75, a second information processing device 76, an exposure light source 77, and/or an exposure light source driving device 78.

The prism 10 and/or the holographic mask 20 may correspond to an optical part. A refractive index matching fluid may be filled between the prism 10 and the holographic mask 20. The prism 10 may transmit a reconstructing beam emitted from the exposure light source 77 to the holographic mask 20 while the direction of the reconstructing beam is not changed, and/or may direct a detection beam emitted from the detection light source 71 to the holographic mask 20 in a vertical direction. An interference pattern due to interference of a diffracted beam and a reference beam of a mask pattern (or a reticle) may be recorded on the holographic mask 20. In more detail, the holographic mask 20 may include a recording layer 21 formed of a photosensitive material (e.g., a photopolymer). The interference pattern of the diffracted beam and the reference beam may be recorded on the photosensitive material so as to form a hologram (or an interference pattern).

The mask stage 30 may support the prism 10 and/or the holographic mask 20. The mask stage 30 may be disposed to be moved by a driving unit 80 (see FIG. 2) in a vertical direction (Z direction). The driving unit 80 may operate when the mask stage 30 is minutely moved. This driving unit will be described in detail later.

A photosensitive material layer 51 formed of the photosensitive material (that is, photoresist) may be coated on the substrate 50. The substrate 50 may be held on the substrate stage 60 using a vacuum chuck or the like, and/or a substrate stage driving device 61 may move the substrate stage 60 in a horizontal direction (XY direction) and/or a vertical direction (Z direction) so as to adjust the position of the substrate stage. The substrate stage driving device 61 may adjust the position of the substrate stage 60 using information output from the detection light source 71, the distance measurement optical system 73, and/or the first information processing device 74.

The detection light source 71 may emit a measurement beam of the distance measurement optical system 73 and/or the thickness measurement optical system 75. The detection light source driving device 72 may change a detection position while moving the detection light source 71.

The distance measurement optical system 73 may include a beam splitter, a cylindrical lens, an optical sensor, and/or an error signal detector. The distance measurement optical system 73 may measure a distance between the recording layer 21 of the holographic mask 20 and the photosensitive material layer 51 coated on the substrate 50.

The first information processing device 74 may adjust the position of the substrate stage 60 such that a depth of focus is appropriately adjusted upon exposure based on the distance between the recording layer 21 and the photosensitive material layer 51, measured from the information transmitted from the distance measurement optical system 73. This is because the gap between the holographic mask 20 and the substrate 50 upon exposure may need to be equal to the gap between the holographic mask 20 and the mask pattern (or the reticle) upon recording in order to accurately transfer the interference pattern recorded on the holographic mask 20 onto the substrate 50. As the size of the substrate 50 may be increased, the load of the substrate stage 60 may be increased. Accordingly, when the substrate stage driving device 61 may move the substrate stage 60, the substrate stage driving device 61 may be burdened by the load of the substrate stage 60 and thus may not accurately move the substrate stage. That is, a movement error may occur and thus the gap between the holographic mask 20 and the mask pattern may not be adjusted with high accuracy.

Therefore, the first information processing device 74 may control the driving unit 80 (see FIG. 2) so as to move the mask stage 30. This driving unit will be described in detail later.

The thickness measurement optical system 75 may include a beam splitter, a photodetector, an amplifier, and/or an analog/digital (A/D) converter. The thickness measurement optical system 75 may measure the thickness of the photosensitive material layer 51 formed on the substrate 50.

The second information processing device 76 may move the exposure light source 77 such that the reconstructing beam irradiated from the exposure light source 77 is scanned on an appropriate exposure region. The second information processing device 76 may control the intensity of the reconstructing beam based on the thickness value of the photosensitive material layer 51 measured by the thickness measurement optical system 75.

The exposure light source 77 may irradiate the reconstructing beam to the recording layer 21 of the holographic mask 20. The exposure light source driving device 78 may expose a desired exposure region of the substrate 50 while moving the exposure light source 77.

The exposure apparatus according to example embodiments may include the main body 1, a mask stage 30 supported by the main body 1, and/or the substrate stage 60 spaced apart from the mask stage 30.

The mask stage 30 may support the holographic mask 20 and/or the prism 10. The mask stage 30 may include the prism holder 11 to fix the prism 10 and/or the mask holder 40 to fix the holographic mask 20. The prism 10 may be fixed to tongs 13 of the prism holder 11 and/or the holographic mask 20 may be fixed to the absorption part 42 of the mask holder 40.

The exposure apparatus according to example embodiments may include the main body 1, the mask stage 30 supported by the main body 1, and/or the substrate stage 60 spaced apart from the mask stage 30.

The mask stage 30 may support the holographic mask 20 and/or the prism 10. The mask stage 30 may include a prism holder 11 to fix the prism 10 and/or a mask holder 40 to fix the holographic mask 20. The prism 10 may be fixed to tongs 13 of the prism holder 11, and/or the holographic mask 20 may be fixed to an absorption part 42 of the mask holder 40. The absorption part 42 may be formed of a vacuum chuck or the like.

The prism holder 11 may be fixed to an upper side of the mask stage 30 and/or the holographic mask 20 may be fixed to a lower side of the mask stage 30. That is, a fixing part 12 of the prism holder 11 and a first support part 31 of the mask stage 30 may be coupled to each other, and/or a seat part 41 of the mask holder 40 and a second support part 32 of the mask stage 30 may be coupled to each other. If the prism 10 and the holographic mask 20 are supported by the mask stage 30, a space S (that may or may not be predetermined) may be formed between the prism 10 and the holographic mask 20. A refractive index matching fluid may be charged in the space S. The refractive index matching fluid may be supplied from a supply part 43 of the mask holder 40 to the space S and/or may be discharged via a discharge part 44 of the mask holder 40.

The mask stage 30 may be supported so as to be moved relative to the main body 1. That is, the driving unit 80 may be disposed between the mask stage 30 and the main body 1. As the shape of the driving unit 80 may be changed, a gap between the mask stage 30 and the main body 1 may be decreased or increased.

The driving unit 80 may include a piezoelectric element 100 and/or a power supply source 90 to supply power to the piezoelectric element 100. When power is applied to the piezoelectric element 100, the shape of the piezoelectric element 100 may be changed. Due to this phenomenon, the mask stage 30 may be moved. That is, when the piezoelectric element 100 may expand, the gap between the main body 1 and the mask stage 30 may be increased and, when the piezoelectric element 100 may contract, the gap between the main body 1 and the mask stage 30 may be decreased. Since, due to material characteristics of the piezoelectric element 100, the limit of a tensile force may be greater than that of a compressive force thereof, the piezoelectric element 100 may be disposed so as to receive the compressive force between the mask stage 30 and the main body 1.

An upper seat arm 33 seated in a support arm 2 of the main body 1 may be provided on an upper side of the mask stage 30. The piezoelectric element 100 may be disposed between the upper seat arm 33 and the support arm 2. Since a gravitational force may be applied to the mask stage 30, the compressive force may be applied to the piezoelectric element 100. As the power supply source 90 may supply power, the shape of the piezoelectric element 100 may be changed. At this time, since the mask stage 30 may be supported by the piezoelectric element 100, the position of the mask stage 30 may be changed due to the change of the shape of the piezoelectric element 100. As the position of the mask stage 30 may be changed, the position of the holographic mask 20 may be changed and, thus, a gap between the holographic mask 20 and an object may be adjusted.

A plurality of piezoelectric elements 100 may be provided. Although, in FIG. 2, the piezoelectric elements may include a first piezoelectric element 100a disposed on the left side of the figure and/or a second piezoelectric element 100b disposed on the right side of the figure, example embodiments are not limited thereto. Referring to FIG. 2, although the same power may be applied to the first piezoelectric element 100a and the second piezoelectric element 100b, a first change amount of the first piezoelectric element 100a and a second change amount of the second piezoelectric element 100b may not be equal to each other. In this case, the mask stage 30 may be tilted and thus the holographic mask 20 may be tilted. This phenomenon may become severe as the distance between the piezoelectric element 100 and the holographic mask 20 may be increased. Accordingly, by minimizing the distance between the piezoelectric element 100 and the holographic mask 20, the tilting of the holographic mask 20 may be minimized even when the first change amount of the first piezoelectric element 100a and the second change amount of the second piezoelectric element 100b are not equal to each other.

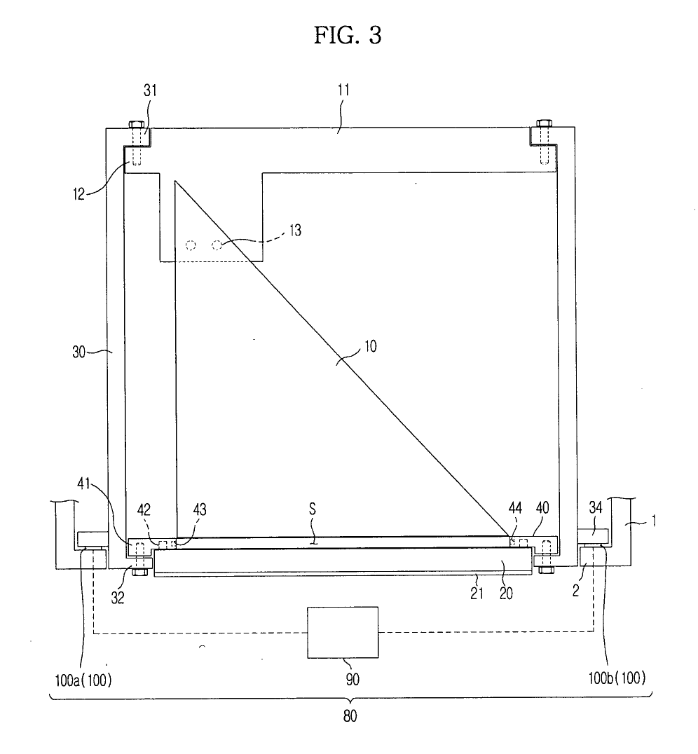

FIG. 3 is a view showing a state of coupling a mask stage and a main body according to example embodiments.

As shown in FIGS. 1 and 3, a lower seat arm 34 seated in the support arm 2 of the main body 1 may be provided on a lower side of the mask stage 30 according to example embodiments. The piezoelectric element 100 may be disposed between the lower seat arm 34 and the support arm 2. Since a gravitational force may be applied to the mask stage 30, the compressive force may be applied to the piezoelectric element 100.

As the power supply source 90 may supply power, the piezoelectric element 100 may expand or contract. At this time, since the mask stage 30 may be supported by the piezoelectric element 100, the position of the mask stage 30 may be changed due to the expansion or contraction of the piezoelectric element 100. As the position of the mask stage 30 may be changed, the position of the holographic mask 20 may be changed and, thus, a gap between the holographic mask 20 and an object may be adjusted.

Although in FIG. 3, the piezoelectric element 100 may include a first piezoelectric element 100a disposed on the left side of the figure and/or a second piezoelectric element 100b disposed on the right side of the figure, example embodiments are not limited thereto. A plurality of piezoelectric elements 100 may be included, similar to the piezoelectric element 100 shown in FIG. 2.

The piezoelectric element 100 shown in FIG. 3 may be different from the piezoelectric element 100 shown in FIG. 2 in that, because the distance between the piezoelectric element 100 and the holographic mask 20 may be small, a first change amount of the first piezoelectric element 100a and a second change amount of the second piezoelectric element 100b may have little influence upon the tilt of the mask stage 30, although the two differ from each other in terms of material characteristics. Therefore, the tilting of the mask stage 30 may be minimized and, thus, the tilting of the holographic mask 20 may be minimized.

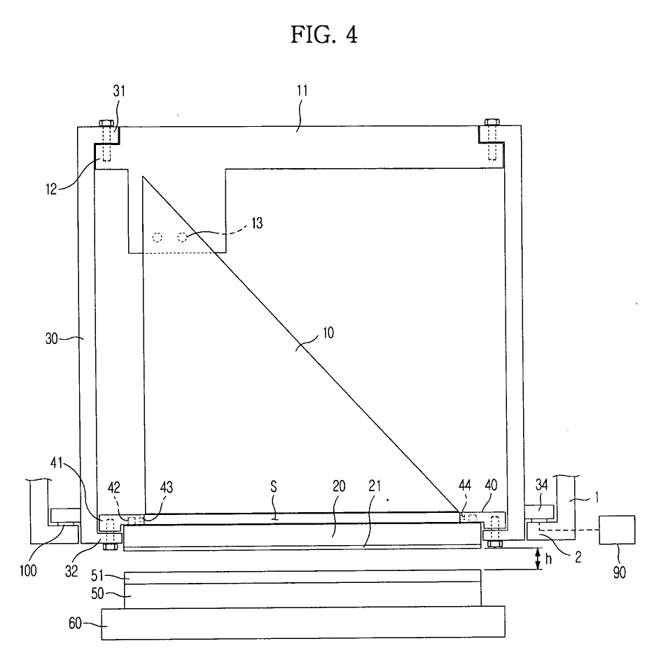

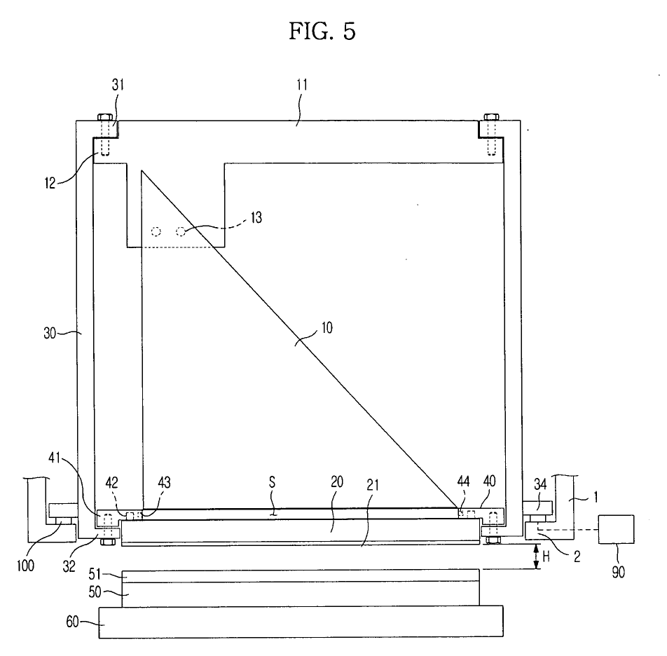

FIG. 4 is a view showing a state in which a gap between a holographic mask and a substrate is out of a depth of focus, and FIG. 5 is a view showing a state in which the gap between the holographic mask and the substrate is within the depth of focus.

The exposure apparatus according to example embodiments may record an interference pattern on the holographic mask 20 while maintaining a gap H (that may or may not be predetermined) between the holographic mask 20 and a mask pattern (or a reticle) upon recording. As shown in FIGS. 1 to 5, in order to accurately transfer the interference pattern recorded on the holographic mask 20 onto the photosensitive material layer 51 of the substrate 50 upon exposure, the gap H (that may or may not be predetermined) may need to be maintained between the recording layer 21 of the holographic mask 20 and the photosensitive material layer 51 of the substrate 50.

The distance measurement optical system 73, the first information processing device 74, and/or the substrate stage driving unit 61 may adjust the distance between the recording layer 21 of the holographic mask 20 and the photosensitive material layer 51 coated on the substrate 50, and/or may control a depth of focus upon exposure. That is, the first information processing device 74 may receive an error signal from the distance measurement optical system 73, may measure the distance between the recording layer 21 of the holographic mask 20 and the photosensitive material layer 51 coated on the substrate 50, may drive the substrate stage driving device 61, and/or may control the position of the substrate stage 60 such that the depth of focus is appropriately adjusted upon exposure. However, if the substrate stage driving device 61 has a large area, the gap between the recording layer 21 of the holographic mask 20 and the photosensitive material layer 51 of the substrate 50 may not be accurately adjusted due to an internal error of the device. In this case, it may be assumed that the gap between the recording layer 21 of the holographic mask 20 and the photosensitive material layer 51 of the substrate 50 is h as shown in FIG. 4. This gap h may not be equal to the gap H between the recording layer 21 of the holographic mask 20 and the mask pattern (or the reticle).

The first information processing device 74 may control the driving unit 80 such that the gap between the recording layer 21 of the holographic mask 20 and the photosensitive material layer 51 coated on the substrate 50 may be maintained within the depth of focus upon exposure with high accuracy. That is, the first information processing device 74 may control the power supply source 90 based on the error signal of the distance measurement optical system 73 so as to supply the power to the piezoelectric element 100. The shape of the piezoelectric element 100 may be changed according to the level of the supplied power. If the shape of the piezoelectric element 100 may be changed, the position of the mask stage 30 supported by the piezoelectric element 100 may be changed and, thus, the position of the holographic mask 20 fixed to the mask stage 30 may also be changed. By moving the holographic mask 20 and the mask stage 30 to fix the holographic mask 20, the gap between the recording layer 21 of the holographic mask 20 and the photosensitive material layer 51 coated on the substrate 50 may be controlled to be within the depth of focus with high accuracy. At this time, the gap between the recording layer 21 of the holographic mask 20 and the photosensitive material layer 51 of the substrate 50 may be H, as shown in FIG. 5, and the gap H may be equal to the gap H between the recording layer 21 of the holographic mask 20 and the mask pattern (or the reticle) upon recording.

Thereafter, the exposure light source 77 may direct the reconstructing beam to the prism 10. At this time, an image of the mask pattern (or the reticle) may be formed due to the interaction between the reconstructing beam and the interference pattern of the holographic mask 20 and/or may be printed on the photosensitive material layer 51 of the substrate 50.

While example embodiments have been particularly shown and described, it will be understood by those of ordinary skill in the art that various changes in form and details may be made therein without departing from the spirit and scope of the present invention as defined by the following claims.

What is claimed is:

1. A holographic exposure apparatus, comprising:
a main body;
a mask stage supported by the main body;
a holographic mask supported by the mask stage; and
a driving unit disposed between the main body and the mask stage in order to move the mask stage relative to the main body.

2. The holographic exposure apparatus of claim 1, wherein the driving unit includes:
a piezoelectric element; and
a power supply source to supply power to the piezoelectric element.

3. The holographic exposure apparatus of claim 1, wherein the piezoelectric element is disposed so as to receive a compressive force by a load of the mask stage.

4. The holographic exposure apparatus of claim 1, wherein the mask stage includes a seat arm disposed on a first side of the driving unit, and
wherein the main body includes a support arm disposed on a second side of the driving unit.

5. The holographic exposure apparatus of claim 4, wherein the seat arm is disposed on an upper side of the mask stage.

6. The holographic exposure apparatus of claim 4, wherein the piezoelectric element disposed between the seat arm and the support arm is disposed adjacent to the holographic mask.

7. The holographic exposure apparatus of claim 6, wherein the seat arm is disposed on a lower side of the mask stage.

8. The holographic exposure apparatus of claim 1, further comprising:
a distance measurement optical system that measures a distance between the holographic mask and an object to be exposed; and
an information processing device that controls the driving unit based on information transmitted from the distance measurement optical system.

9. The holographic exposure apparatus of claim 2, further comprising:
an object to be exposed;
wherein when the power supply source supplies power to the piezoelectric element, the driving unit adjusts a distance between the holographic mask and the object to be exposed.

10. The holographic exposure apparatus of claim 2, further comprising:
an object to be exposed;
wherein when the power supply source supplies power to the piezoelectric element, the driving unit adjusts a distance between a recording layer of the holographic mask and the object to be exposed.

11. The holographic exposure apparatus of claim 1, further comprising:
an object to be exposed;
wherein the object to be exposed includes a photosensitive material layer.

12. A holographic exposure apparatus, comprising:
an object supported by a substrate stage;
a holographic mask spaced apart from the object and supported by a mask stage;
a main body supported by the mask stage; and
a driving unit disposed between the mask stage and the main body in order to control a gap between the mask stage and the main body.

13. The holographic exposure apparatus of claim 12, wherein the driving unit includes:
a piezoelectric element; and
a power supply source to supply power to the piezoelectric element.

14. The holographic exposure apparatus of claim 12, wherein the piezoelectric element is disposed so as to receive a compressive force by a load of the mask stage.

15. The holographic exposure apparatus of claim 12, wherein the mask stage includes a seat arm disposed on a first side of the driving unit, and
wherein the main body includes a support arm disposed on a second side of the driving unit.

16. The holographic exposure apparatus of claim 13, wherein when the power supply source supplies power to the piezoelectric element, the driving unit adjusts a distance between the holographic mask and the object.

17. The holographic exposure apparatus of claim 13, wherein when the power supply source supplies power to the piezoelectric element, the driving unit adjusts a distance between a recording layer of the holographic mask and the object.

18. The holographic exposure apparatus of claim 12, wherein the object includes a photosensitive material layer.

19. A holographic exposure apparatus, comprising:
a main body;
a mask stage supported by the main body;
a holographic mask supported by the mask stage; and
a piezoelectric element disposed between the main body and the mask stage;
wherein the main body includes a support arm that supports the piezoelectric element at a first side of the piezoelectric element, and
wherein the mask stage includes a seat arm that supports the piezoelectric element at a second side of the piezoelectric element.

20. The holographic exposure apparatus of claim 19, further comprising:
a prism supported by the mask stage;
wherein a refractive index matching fluid is disposed between the prism and the holographic mask.
